(19) United States
(12) Patent Application Publication
(10) Pub. No.: US 2002/0161696 A1
(43) Pub. Date: Oct. 31, 2002

(54) Corporate market

(76) Inventor: Carol A. Gebert, Cambridge, MA (US)

Correspondence Address: MINTZ, LEVIN, COHN, FERRIS, GLOVSKY, AND POPEO, P.C., ONE FINANCIAL CENTER, BOSTON, MA, 02111, US

(21) Appl. No.: 10/118,784

(22) Filed: Apr. 9, 2002

Related U.S. Application Data
(60) Provisional application No. 60/282,525, filed on Apr. 9, 2001.

(51) Int. Cl. G06F 17/60

(52) U.S. Cl. 705/37; 705/14

(57) ABSTRACT

A method of implementing a controlled market includes providing guidelines, to traders, regarding a reward associated with first entity-controlled securities that are associated with a selected project from at least one of a plurality of an entity's projects and a further associated with an event related to the selected project, providing the first entity-controlled securities to each trader, allowing each trader to trade the first entity-controlled securities and at least second entity-controlled securities, acquiring, from the traders, at least some of the first entity-controlled securities, and issuing the reward to each trader from whom the first entity-controlled security is acquired if the related event is realized, where at least one of the providing the first entity-controlled securities, the allowing each trader to trade, and the issuing the reward is dependent upon a trader, to whom a first entity-controlled security is provided, from whom a first entity-controlled security is acquired, or to whom the reward is issued, taking a trader action.

### CROSS-REFERENCE TO RELATED ACTIONS

This application claims the benefit of U.S. Provisional Application No. 60/282,525 filed Apr. 9, 2001.

### FIELD OF THE INVENTION

The invention relates to a corporate economy and more particularly to using a corporate economy for allocating resources, making acquisition and investment decisions, generating business intelligence, motivating targeted behaviors and valuing assets.

### BACKGROUND OF THE INVENTION

To date, executive management of corporations relies on centralized decision making, with staff reward systems only distantly related to individual performance. Information is channeled through defined reporting chains from the periphery to the centralized unit of management and resource allocation flows in the reverse direction, again through defined, hierarchical paths. This method may, however, lead to, e.g., slow response times, inappropriate action, internal political struggles and other problems synonymous with bureaucracy. Bureaucratic methods of corporate organization have a long historical precedent, rooted in military organization.

### SUMMARY OF THE INVENTION

The invention brings advantages of market forces to corporate environments as an alternative or adjunct to bureaucratic structures. The invention creates competitive forces between alternative internal interests, in contrast with existing business structures, which attempt to minimize internal competition. Using the invention, markets are established in place of bureaucratic processes allowing market forces to play out the priorities otherwise set by central management. In the market, securities based on in-house assets or events are traded using in-house money. A reward system is provided that is a collection of market-related mechanisms by which participants accumulate and redeem rewards. The invention is preferably implemented at least partially on a computer network.

The invention provides for a controlled market economy to be created, where professional staff are given the opportunity to invest in securities corresponding to outcomes of events related to the company's assets, staff, resources, processes, development or other projects, planning scenarios, or other internal metrics, referred to herein as projects. The resulting patterns of investment are an expression of the knowledge of the professional staff on these projects or events. Analysis of the market data therefore yields insight into the collective knowledge of the organization with minimal, or at least reduced, distortions. The invention can be configured so that the currency used for investment carries actual budgetary allocation power, or so that ownership of investments carry special rights, responsibilities and privileges. These rights allow defined amounts of decision making power to be delegated to the market from the central management body. Access to the market and its reward structures is modulated by the measured and tracked behaviors of individuals in the community of participants.

In general, in an aspect, the invention provides a method of implementing a controlled market. The method includes providing guidelines, to traders, regarding a reward associated with first entity-controlled securities that are associated with a selected project from at least one of a plurality of an entity's projects and a further associated with an event related to the selected project, providing the first entity-controlled securities to each trader, allowing each trader to trade the first entity-controlled securities and at least second entity-controlled securities, acquiring, from the traders, at least some of the first entity-controlled securities, and issuing the reward to each trader from whom the first entity-controlled security is acquired if the related event is realized, where at least one of the providing the first entity-controlled securities, the allowing each trader to trade, and the issuing the reward is dependent upon a trader, to whom a first entity-controlled security is provided, from whom a first entity-controlled security is acquired, or to whom the reward is issued, taking a trader action.

Implementations of the invention may include one or more of the following features. The method further includes pursuing a project based on trading of the entity-controlled securities by the traders. The pursuing is based on at least one of amounts of the entity-controlled securities traded by the traders for the selected project and related event, patterns of acquisition of the entity-controlled securities, and prices of the entity-controlled securities. The pursuing comprises at least one of funding or working on the selected project.

Implementations of the invention may also include one or more of the following features. The allowing the traders to trade the first entity-controlled securities includes initially allowing the traders to trade, and ongoing allowing of the traders to trade, while a project is in progress. The method further includes pursuing a project based at least in part on ongoing trading of the first entity-controlled securities by the traders. The ongoing acquiring includes trading of different entity-controlled securities.

Implementations of the invention may also include one or more of the following features. The trader action is at least one of responding to a survey and trading the first entity-controlled security. The traders have knowledge relevant to a likelihood of at least one event associated with at least one project being realized. The method further includes making available knowledge relevant to the projects accessible to the traders before the acquiring. The knowledge is made available by the traders.

Implementations of the invention may also include one or more of the following features. The traders acquire the entity-controlled securities by trading items of value for the entity-controlled securities. The method further includes distributing varying amounts of the items of value to the traders. The varying amounts of the items of values are dependent upon at least one of each trader's likely impact upon the realization of the event, knowledge of the likelihood of realization of the event, and taking of the trader action by the trader. The items of value are entity-controlled currency. Possession of the entity-controlled currency carries at least one right associated with the entity. The at least one right is to obtain resource allocation for a project. The method further includes providing the entity-controlled currency periodically. The method further includes lending the entity-controlled currency to at least one of the traders. The method further includes exchanging the items of value for at least one of products, services, and work-related commodities available through an entity store.

Implementations of the invention may also include one or more of the following features. The related event is an end result of the selected project. The at least a portion of the providing, acquiring, and issuing is performed by a software program. At least one of the providing the first entity-controlled securities, the allowing each trader to trade, and the issuing the reward is inhibited unless the trader takes the trader action. Possession of at least one of the first entity-controlled securities carries at least one right associated with the entity. The right is at least one of a right to share in profit derived from, and a right to obtain payment for use of, a resource associated with the at least one entity controlled security.

In general, in another aspect, the invention provides a method of obtaining objective feedback for projects of a company from relevant persons. The method includes providing company-regulated currency to relevant persons, providing guidelines to the relevant persons for rewards for investing in company-regulated securities associated in each of a plurality of company projects, the rewards being based on realization of a specified event associated with each project, investing by the relevant persons in at least one of the company projects by trading the company-regulated currency for shares of project interest, obtaining information from the relevant persons regarding trades made by the relevant persons, and issuing the reward corresponding to each of the company-regulated securities whose associated event is realized to each trader that holds the company-regulated security upon even realization and that has provided information regarding at least one trade of the company-regulated security.

Implementations of the invention may include one or more of the following features. At least one event is a milestone of a company-internal project. The reward is a salary bonus. The investing by the relevant persons is performed over a computer network regulated by the company. The method further includes providing computer accounts of the company-regulated currency for the relevant persons. The method further includes using software to log and analyze data associated with the investing, the data including information about the relevant persons that are investing and about investing activity. The relevant persons include employees of the company.

In general, in another aspect, the invention provides a computer program product for implementing an entity-controlled market, the computer program product residing on a computer-readable medium and including computer-executable instructions for causing a computer to provide guidelines, to traders, regarding a reward associated with first entity-controlled securities that are associated with a selected project from at least one of a plurality of an entity's projects and a further associated with an event related to the selected project, provide the first entity-controlled securities to each trader, allow each trader to trade the first entity-controlled securities and at least second entity-controlled securities, acquire, from the traders, at least some of the first entity-controlled securities, and issue the reward to each trader from whom the first entity-controlled security is acquired if the related event is realized, where the instructions are configured to at least one of provide the first entity-controlled securities, allow each trader to trade, and issue the reward depending upon a trader, to whom a first entity-controlled security is provided, from whom a first entity-controlled security is acquired, or to whom the reward is issued, taking a trader action.

Implementations of the invention may include one or more of the following features. The trader action is at least one of responding to a survey and trading the first entity-controlled security. The computer program product further includes instructions for causing the computer to make knowledge relevant to all the projects accessible to all the traders before the computer acquires the first entity-controlled securities. The computer program product farther includes instructions for causing the computer to distribute varying amounts of the items of value to the traders for obtaining the first entity-controlled securities. The varying amounts of the items of values are dependent upon at least one of each trader's likely impact upon the realization of the event, knowledge of the likelihood of realization of the event, and taking of the trader action by the trader. The related event is an end result of the selected project.

Various aspects of the invention may provide one or more of the following advantages. Efficiency of corporate operations and effectiveness of corporate action (e.g., in producing products) can be improved. Accounting transparency and agility of corporate response to external events can be improved, and management effort can be reduced. Collective knowledge of controlled-market participants can be evaluated and relied upon in making decisions, e.g., that influence company projects. Individual knowledge, including candid knowledge, of market participants can be extracted. Controlled-market participation, including obtaining shares/money to use in trading, trading itself, and redeeming security shares for rewards can be made conditional on trader behavior from which additional information can be obtained.

These and other advantages of the invention, along with the invention itself, will be more fully understood after a review of the following figures, detailed description, and claims.

### BRIEF DESCRIPTION OF THE FIGURES

FIG. 1 is a schematic block diagram of a controlled-market system.

FIG. 2 is a schematic block diagram of a functional marketplace shown in FIG. 1 becoming an operational marketplace as shown in FIG. 1.

FIG. 3 is a schematic block diagram of the functional marketplace shown in FIGS. 1-2.

### DETAILED DESCRIPTION OF PREFERRED EMBODIMENTS

The invention provides techniques for producing and operating a company-controlled marketplace. The marketplace is regulated by an entity, e.g., a company, including establishing guidelines, defining securities, encouraging trader behaviors, monitoring trader behaviors and security “prices,” providing rewards, and making decisions regarding projects of the entity based upon market activities, including security “prices,” trader behaviors, and information obtained from traders (e.g., in response to inquiries into trading activity).

Implementation

The invention can be implemented in two parts: (a) the construction of computer-based software and hardware components, and (b) the engineering of several business processes instituted, e.g., by executive directives.

Computer Hardware and Software

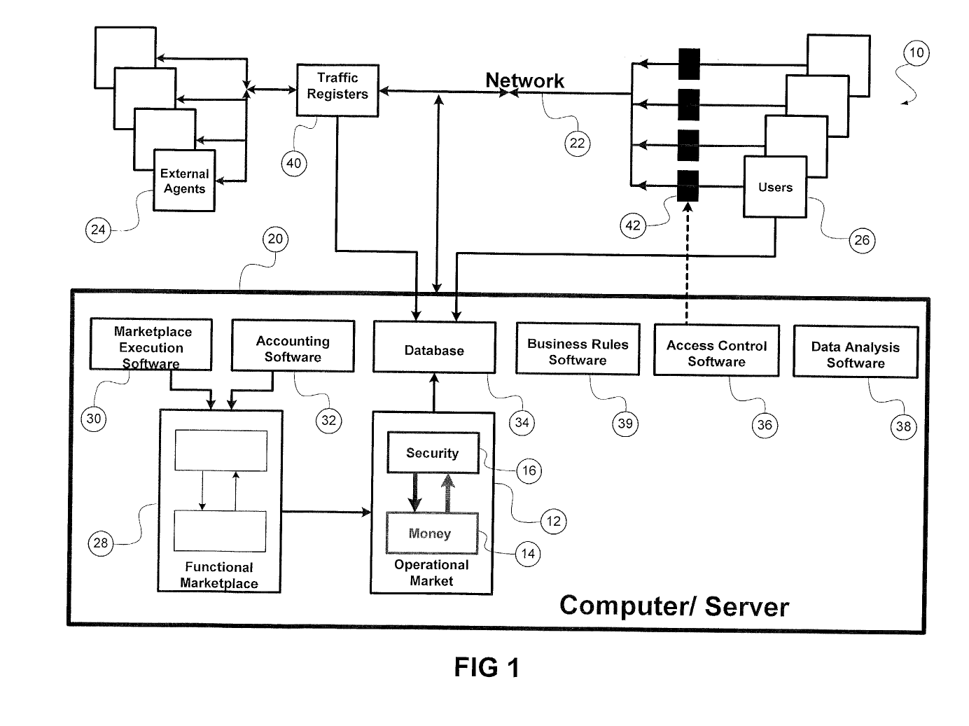

Referring to FIG. 1, a system 10 includes a computer or server 20, a network 22, external agents 24, user devices 26, traffic registers 40, and access controllers 42. The user devices 26 can be computer terminals, keyboards, voice command receivers and the like that present interfaces for users of the user devices 26. The devices 26 can be used to remotely access the computer 20 through the network 22. The network 22 connects the computer 20 and the user devices 26 to the external agents 24 that comprise databases and computers or servers. The traffic registers 40 can monitor and record activity by the user devices 26. Access to the user devices 26 is regulated by the access controllers 42 under direction from the computer 20.

The computer 20 includes several portions including software modules, and a database, for implementing various fimctions. As shown, the computer includes an operational marketplace module 12, a functional marketplace 28, a marketplace execution module 30, an accounting module 32, a database 34, a business rules module 39, an access control module 36, and a data analysis module 38. The accounting software 32 can execute account and accounting functions and contribute to producing the functional marketplace 28. The database 34 is configured to store relevant data. The business rules module 39 is configured to encode business rules that manipulate the data stored in the database 34. The access control module 36 is configured to actuate the access controller 42 to regulate access to the computer 20 by the user devices 26. The software modules are configured as computer-executable instructions stored on computer-readable memory for implementing their respective functions, as described in more detail below. The software and database components may be installed by any usual method employed by those skilled in the art of information technology.

The marketplace execution software 30 is configured to execute marketplace (e. g., trading) functions and so contribute to the creation of the functional marketplace 28. This software 30 may be, e.g., software produced by ePIT®, Inc., located at 351 California Street, San Francisco, Calif., 94104. The market making algorithm could be any kind used in electronic or traditional markets, and such algorithms are familiar to those skilled in the art.

The database 34, for example, can store data about the user devices 26, and about information seeking and other behavior of users of those devices 26. The data stored in the database 34 may be collected, for example, by the network traffic registers 40. Data from the traffic registers 40 include information regarding the market access behaviors of the users. The database 34 can also store information generated by the operational market 12. The database 34 may also be linked to other databases (not shown). Data regarding the users are transmitted by the user devices 26 directly to the database 34. These data include, e.g., demographics of the users.

Executive Directives Preferably executives, their agents, or other individuals who are preferably not participants in the market, design the market. The market design may be performed only once, at the beginning of operations, but preferably, the market design is a dynamic process that is on-going during market operation.

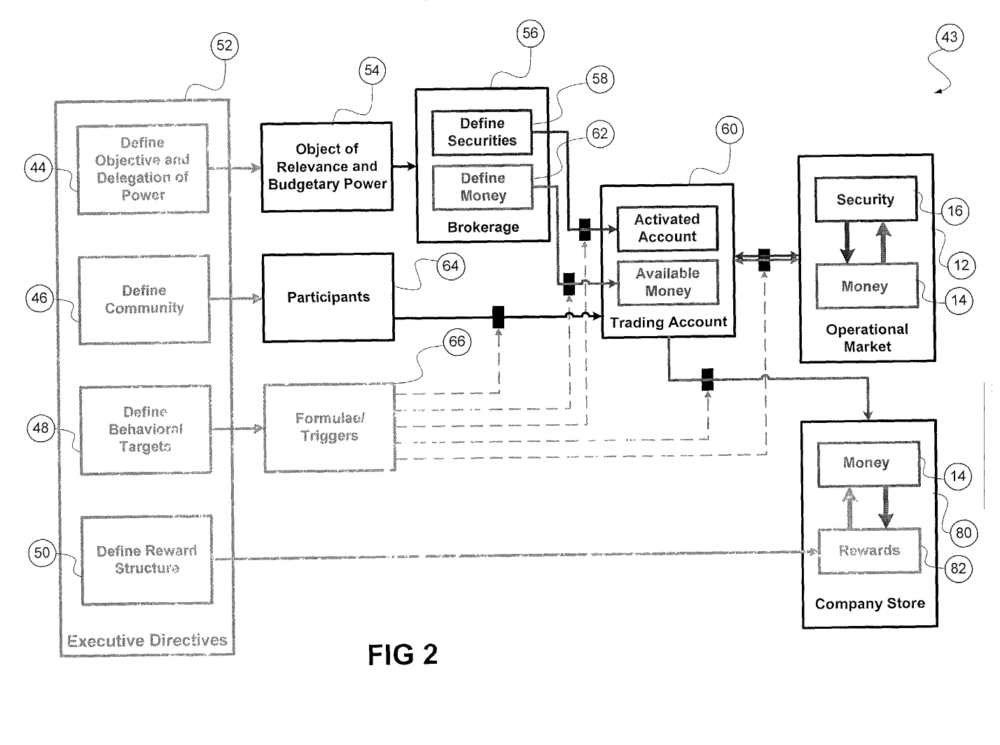

Referring also to FIG. 2, the functional marketplace 28 becomes the operational marketplace 12 by loading the functional marketplace 28 with securities 16 and money 14 according to a process 43 including the stages shown. The process 43, however, is exemplary only and not limiting. The process 43 can be altered, e.g., by having stages added, removed, or rearranged. The operational marketplace 12 is a controlled market as described below, with the market being configured and regulated by an entity desiring to obtain information/knowledge regarding one or more projects of the entity.

At stage 52, marketplace production is initiated by designers, here executives of a company. The designers design the marketplace using consulting practices familiar to those skilled in the art, e.g., meetings and solicitations for ideas (e.g., through email) for information gathering, and the construction of process diagrams, organizational charts and the like for understanding relationships. Through the design process, the designers produce a ‘game’ where alternative interests, as expressed by individual participants, compete. Stage 52 includes stages of defining one or more objectives and delegating power 44, defining a community 46, defining behavioral targets 48, and defining a reward structure 50.

Definition of Objective and Delegation of Power At stage 44, the executives define one or more objectives, such as any commonly understood business goal (e.g. based on a process, asset or project). Exemplary business goals include, but are not limited to, the achievement of a project development milestone, the collection of intelligence regarding sales forecasts, or the acquisition of a technology. Preferably, a precisely defined and measurable event relevant to the objective (e.g. a product development milestone) is selected at stage 54 as an object of investment. An event external to the corporate environment could be, or also be, selected. Regardless of source, the event selected at stage 54 becomes the basis of the investment prospectus for the financial security defined at stage 58, as described, e.g., by the Iowa Elections Market or Hollywood Stock Exchange. The accounting software 32 produces a brokerage function 56 and either distributes shares of the securities 16 directly into trader accounts 60, or offers them for sale in the market 12. When the event occurs as stipulated, the securities payout a predefined amount of money to holders of shares of those securities.

In-house money 62 is also created by the accounting software 32 in the brokerage function 56 and distributed into the trading accounts 60 of participants. The money is a means of exchange in the corporate economy and is used, for example, by traders to trade securities in the marketplace 12.

Also at stage 44, executives define the level of decision making power delegated to market forces by rights that are associated with the securities and/or the money. For example, in embodiments where the objective is one of intelligence gathering only, then preferably the only rights that are associated with the security are ones governing payout of the shares upon event outcome. In embodiments where the objective is one of acquisition, then budgetary allocations are preferably associated with the money 62.

Executives establish formulae and rules by which (preferably periodic) endowments of shares and/or money 62 are made into the trading accounts 60 of traders, or offered in the marketplace. In some embodiments, these formulae may be triggered solely on a time schedule, but in other embodiments, the endowment formulae may be triggered or altered by the behaviors of participants as described below.

Definition of Community

At stage 46, the executives define the community of participants 64 from among the users 26. The community is defined by several criteria related to the level of involvement that each person has with the defined event or its related process, asset or project. This includes each person's work duties, knowledge and decision making power.

The participants 64 defined in the market 12 can be of several classifications. Preferably, the participants 64 include traders who are given direct access to the trading functions in the market 12 by the access control software 36. The participants 64 can also include lenders or other individuals who provide various services for other users, such as management of investment portfolios.

Lenders may also receive accounts of the money 62, e.g., when executives issue money during market design or adjustment. Unlike traders who have direct access to the market, lenders use their money 62 to lend to traders or to other parties. This lending of the money 62 is subject to lending rules and interest rates set by executive directive as part of market design defined at stage 52.

Definition of Reward Structure

The traders may also use the money to buy real rewards 82 at a company store 80, which is also enabled by the marketplace software 30. These real rewards 82 are supplied by the company executives and could take any form perceived by the participants 64 as having value. The amount and periodicity of money that can be exchanged for the real rewards 82 by any given trader is controlled by rules and exchange rates embodied in formulae 66 and triggered by individual, measured behaviors targeted during the market design defined at stage 52. For example, the amount of the money 62 able to be exchanged for the rewards 82 may be a function of trading activity in the marketplace 12, where ‘trading’ is a targeted behavior.

The rewards 82 may be offered at a set “price” of the corporate money 62, or may have a competitive or luck element to their purchase. For example, a limited number of the rewards 82 may be auctioned to the highest bidders from among the traders. A lottery format may also be used to allocate a reward, where the money 62 is used to buy tickets.

Definition of Behavioral Targets

Individual staff behaviors targeted by executives as desirable are nominated, and appropriate tracking metrics are established at stage 48. Reward formulae are established for each behavior and are embodied in the access control software 36 and the business rules software 39 such that the dynamics of participation in the market are altered when the trader engages in the behavior. The measurements of these behaviors trigger the formulae 66. The formulae 66 may comprise, for example, increases in the size or frequency of endowments of shares or money 62 to trader accounts, the amount of the money 62 able to be redeemed at the company store 80 or changes to trading limits. It is preferable to track the behaviors at the individual level, so that traders are rewarded directly for their personal behaviors.

The behaviors can include acts directly associated with the market 12 or independent of it. An example of an associated behavior is the completion of a questionnaire/survey during the trading order process in the market 12. The survey may inquire into the reasons for a trade (either buying or selling shares/securities) and the trader may be given more (less) shares or money 62 for responding (not responding), with the amount of shares or money 62 preferably being independent of the substance of the response. Another behavior is trading; the payout to a trader holding correct shares could be limited, e.g., to market money that cannot be used to buy rewards 82 at the store 80 if the shares are never traded. An example of an independent behavior is providing expert advice on some topic to whomever requests it, in a manner where the provision of that advice is recorded.

The configuration of tracked behaviors changing the dynamics of participation can also be made in the negative, so that undesirable behaviors trigger reductions in the rewards 82 to individual traders. That is, the money 62 or shares can be removed or market rights changed or revoked when users are detected as engaging in other activities, targeted by the executive as undesirable behavior. These triggers are part of the policing function of operations.

The rewards 82 for behaviors may also be triggered after the fact, when a second, related event occurs. For example, submitting documented work into an archive may be a targeted behavior whose reward is triggered (to the author) when a third party accesses the document. These indirect triggers may result in the rewards 82 being awarded multiple times to the same individual for a single act (e.g. of documentation).

Activation and Regulation

Access to the economy is a software control point, enabled by passwords distributed to traders and other participants 64. Passwords are preferably earned by the participants 64 through targeted behaviors such as the completion of a training and certification program. Certifications and the password access they allow may be changed or revoked for individual participants 64. Reasons for this may include the participant 64 leaving the corporate environment, changing his or her job responsibility into a non-participating category (such as to the executive layer) or being caught, by a policing function, breaking the rules.

The economy has several points of regulation, including the amount of money 62 endowed to the participants 64, the amount of the money 62 able to be redeemed for the rewards 82, interest rates, and other parameters familiar to persons skilled in the arts of economics and/or banking.

It is preferable for the economy to have legislative and judiciary functions, to adjust the rules and the formulae 66 and to resolve ambiguities (for example in the securities definitions) as appropriate. The composition of these bodies and their procedures are likely to vary with each company in which the economy is installed, due to reasons of corporate culture. In any case, the implementation can be made using consulting practices familiar to those skilled in the art of governance.

Description of Operation

An operational market 12 can be constructed as outlined above. The activities of the market 12 are enabled by the marketplace execution software 30 and the accounting software 32.

Exchange Events

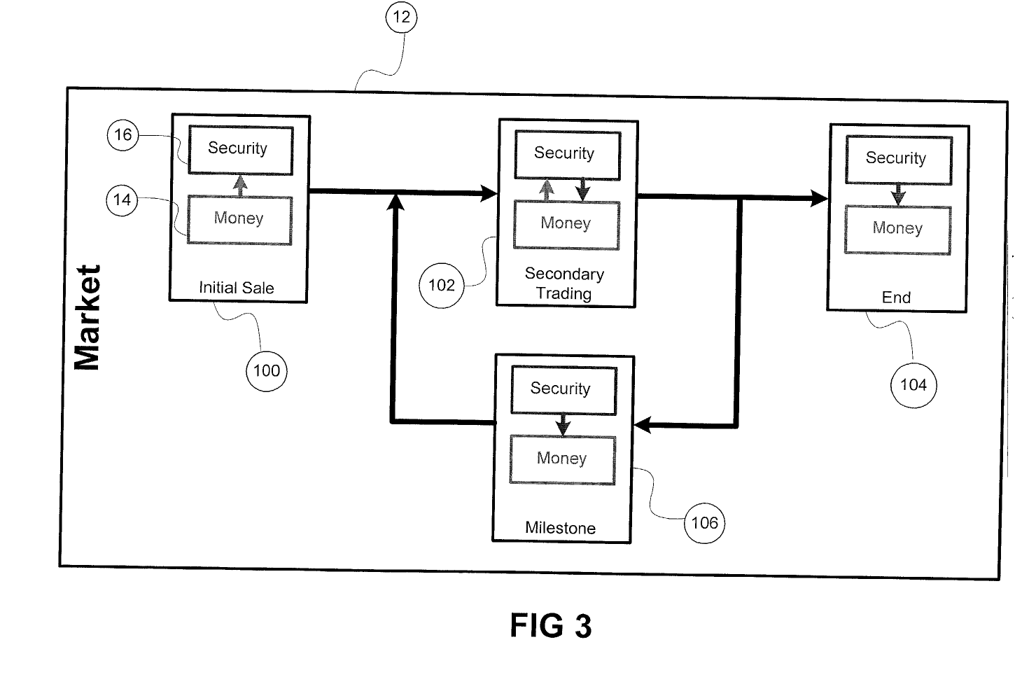

Referring also to FIGS. 1-2, the basic exchanges that occur in the market 12 are outlined in FIG. 3. The securities 16 are preferably offered by the executive in the market 12 for the first time 100, and are purchased by traders using the money 14. Preferably, traders may exchange the securities 16 among themselves in secondary trading 102. The securities 16 may pay out money periodically to traders holding the securities 16, as per rights associated with the securities 16, and triggered by events relating to the event/asset/project underlying the security definition. When an end-point event occurs that is stipulated in the security definition, each security pays out 104 a defined amount of money to the holder of the security 16. This is achieved by the executive ‘buying back’ the security 16 from holders for the defined amount, and removing the security 16 from the market 12.

The brokerage function of the market may also allow short-selling, long-trading and other forms of trading services familiar to those skilled in the art of financial services.

In some embodiments, the holding of shares by a trader (preferably in the majority of those outstanding) is accompanied by the right to issue new securities, for example, based on a subdivision of the objective underlying the original security. In this way, the holder of those shares acts somewhat like a brokerage.

In embodiments where the money 14 is accompanied by rights to access budgetary line items for expenditure external to the corporate economy, a corporate exchange bank preferably exists. The money 14 can be exchanged for legal tender at this bank, subject to rules and exchange rates set by the executive during market design.

Influences on Trading Activity

During the time that a security 16 is open, its price in the market 12 will change in response to demand from traders. This demand will fluctuate depending on several influences. These include, for example, information newly acquired by traders either directly or indirectly relevant to the event associated with the security 16. This new information may be pre-existing, newly created or found, and internally or externally generated. Competitive forces are also created between the securities 16, in embodiments where the same class of money may be used to buy multiple securities. This also influences fluctuations in demand for the securities 16.

Data

These, and other, influences result in fluctuations in trading activity including price movements of the securities 16. These are among the data that are deposited in the database 34. The database 34 can store:

Information related to the event/asset/project underlying the security definition.

Information relating to the tracking of behaviors.

Traffic data from the registers of network traffic, including identity of users, search requests for data, website or database destinations visited and frequency of visits.

Market generated data including trading activity and price movements and account data.

Information gathered during the trading process, including citations to evidence supporting the trading decision and surveys related or unrelated to the security being traded.

Trader details such as relationship with project/asset, field of expertise, position in company or other demographic details.

To Extract Intelligence

The data in the database 34 are analyzed with the data analysis software 38. This yields information of several types. It yields information able to inform adjustment of the market design, triggering of reward formulae, adjustment of software features and executive-level business intelligence.

Examples of business intelligence, include:

The opinions on future project events, such as timing, size or yes/no (e.g., whether to start or continue funding a project).

ROI (Return on Investment) assessments of projects,

Forecasts for the outcomes defined in the security definition.

The opinions on whether a past project event has changed the forecast for a future event.

Identification and usage of knowledge resources, including databases, people, information sources and company reports.

Importance, accuracy and relevance of knowledge resources.

Quality monitor for company documentation.

Monitoring of staff behavior.

To Drive Behaviors

Behaviors can be reinforced with internal markets, as described above. Preferably, the behaviors are tracked automatically, with the reward formulae 66 embodied in the market 12 and the accounting software 32. Ratios and parameters of the reward formulae 66 are preferably under the control of the executive or the executive's administrative agents, so that the behavioral drivers can be managed on an on-going basis.

Detail on Components

Market

The market 12 for the securities 16 provides a collection of functions and events that allow the active exchange of the money 14 for a specific kind of financial security. Multiple securities 16 may be offered simultaneously in separate markets 12. A marketplace may be a website (or other electronic destination) where trading of the securities 16 can occur.

Participants

Users may include everyone who accesses the market 12 or the data it generates. Users may include analysts, police, market regulators and market participants. The market participants 64 may be further divided into traders, lenders and other service providers. Exemplary traders include any, preferably non-executive, person (e.g., staff member, contractor, project-related agent), whether a company employee or not, whose expertise and/or knowledge and/or opinions derived therefrom are useful and/or needed to inform executive decision making, such as forecasts for success or ROI assessments for projects in development, but who can individually insignificantly affect project outcomes. Specific examples include scientific staff, lawyers, marketing professionals, sales force, manufacturing or processing staff. This preferably does not include executives such as CEO or Chairman or others that can significantly affect outcomes of corporate events underlying the security definitions. Lenders may be specially certified participants or may be corporate institutions or departments created by executive mandate, such as the corporate bank. A single individual user may have a combination of classifications, for example as both a trader and a lender.

Preferably, a participant 64 is an individual person. The participants 64 may, however, include groups of individuals or a company division. Other non-participating users have roles as observers, analysts and police.

Access of potential participants 64 to the market 12 may be restricted based on prospective trader actions. For example, the traders may be required to provide information regarding why they are trading in order to be allowed to trade.

Securities

The securities 16 are created as definitions of outcomes (e.g., occurrences or non-occurrences of events) that trigger rewards. Preferably, these definitions map closely to the manner in which the company creates value for its stakeholders. The events may occur only once or multiple times. For example, a security 16 can be created around a development project achieving a milestone, which occurs only once, or around usage of a technology resource, which occurs multiple times.

A security can be framed, e.g., as:

1. An outcome from several possibilities. In this case, the definition may resemble “If outcome 1, then reward for securities forecasting outcome 1=A and reward for securities forecasting outcome ‘not 1’=B” and “If outcome 2, then reward for securities forecasting outcome 2=C and reward for securities forecasting outcome ‘not 2’=D” where A>B and C>D in some measure of worth or perceived worth.

2. The timing of a single outcome. In this case, the definition would resemble “If outcome occurs by date 1, then reward for securities forecasting date 1=A, and reward for securities forecasting date ‘after 1’=B” and “If outcome occurs after date 1, then reward for securities forecasting date 1=C and reward for securities forecasting date ‘after 1’=D” where A>B and C<D.

3. The quantity associated with an event. In this case, the definition would resemble “If an event happens of ‘size X or greater’, by date Y, then reward for securities forecasting ‘size X or greater’=A, and reward for securities forecasting of ‘less than size X’=B, etc.

The securities 16 could be, e.g., in the form of:

1. A futures contract.

2. A security upside or ownership stake in the specific project (e.g., product or service). This resembles the common definition of ‘equity.’

3. A derivative security based on ownership or upside stakes in the project.

4. A collection of securities (i.e. a ‘mutual fund’).

5. A convertible security.

6. A bond.

7. A bond fund.

8. A ‘bet’ as commonly understood.

9. Any financial vehicle familiar to those skilled in the art.

The securities definitions into which the professional staff invests could derive, e.g., from:

1. Intellectual Property (IP) or other legally recognized asset.

2. Collections of securities.

3. In-house or joint-venture projects.

4. Alliances, partnerships and other corporate relationships.

5. Projects, companies or IP offered for acquisition.

6. Corporate events, such as the achievement of sales figures or manufacturing milestones.

7. A defined objective and associated tasks.

8. Usage of a resource, e.g. a machine or device.

9. Actions by a specific person or group of people.

10. A decision by an external agent (e.g. government agency)

11. An internal corporate metric.

12. An external corporate metric.

13. The corporate stock price.

Preferably, securities are initially offered by the executive to traders in the market 12. Securities may also be allocated directly to traders who offer them in the market 12.

Preferably, there will be no reward (reward=nothing) for the securities 16 that do not forecast (are not associated with) what actually happens. Partial rewards may be paid for forecasts that are partially realized. Some reward may be paid out for inaccurate forecasts, e.g., to encourage participation.

Security Rights

In at least one embodiment, the holder of a security 16 retains no rights over the project, event or asset underlying the security definition, other than the rights associated with payout upon event outcome. In some embodiments, the holder of a share will retain selected rights associated with the project, event or asset. For example, for securities based on the usage of a specific resource, holders receive income paid by the users of the resource. The actual amount of income received is preferably a function of how many shares are held by the holder in comparison with the total number issued. In further embodiments, holders of shares of a security 16 receive rights to create and offer new securities 16 for investment.

Money

The money 14 in the market 12 may be in-house means of exchange and not necessarily legal tender used in the macroeconomy. The in-house money 14 is created by executive directive. It may either be solely for in-house exchange (e.g. resembling Monopoly money), or may carry actual resource allocating power such that, e.g., the amount of money 14 obtained in exchange for securities determines the amount of actual legal tender provided for obtaining resources (e.g., products and/or services for a project). The money 14 is assigned directly to traders. The money 14 may also be able to be purchased by traders and/or lenders with legal tender or services provided to the company.

Preferably, there is only one kind of money and it may be used in any and all of the markets 12 to buy any or all of the securities 16. Various kinds of money, however, can be created that are specific in their use to buy specific securities 16.

Marketplace and Banking Functions

Preferably, the marketplace is able to perform many, if not all, of the functions that marketplaces in the macroeconomy are able to perform, and that are familiar to those skilled in the art. These include, but are not restricted to:

a. Accepting bids for securities by traders.

b. Accepting asks for securities by traders.

c. Performing clearing, matching or settlement of bids and asks.

d. Brokerage.

i. Storage and Accounting of Securities.

ii. Issuance of new securities.

iii. Administration of rewards paid out by securities.

iv. Policing of rules.

Banking functions may be allowed upon executive directive. These include but are not restricted to:

1. Money issuance to traders and/or lenders.

2. Current accounts. The participants 64 may deposit their currency 14 into an account that may or may not bear interest. Securities purchases and sales are settled with the money 14 from or into the current account.

3. Redemption of the money 14.

4. Loans. Traders and/or lenders may borrow the money 14. Loans may bear interest rates, and may be subject to collateral or margin rules.

5. Policing of rules.

Behavioral Targets

The rewards 82 may be triggered to individuals by:

a. Holding shares of a security 16 upon event outcome. In this case, the reward 82 is in the security payout.

b. Holding shares of a security 16 when an intermediate event occurs associated with the underlying event, project, resource or asset. In this case, the reward 82 is in the form of a dividend.

c. Engaging in high volume trading activity. The rewards 82 may include the right to redeem some money at the company store 80.

d. Being an author on a citation or reference nominated by a third party as part of the trading order process. The rewards 82 may include shares in the security 16 traded by the third party.

e. The completion of surveys, questionnaires or tasks associated with the trading order process. The rewards 82 may include shares of the security 16 being offered for trade by the trader.

f. Quality or quantity of input or comments made as part of the trading order process.

g. Sharing of ideas, suggestions or knowledge in any trackable form.

h. Cooperating with or providing services to other parties.

i. Engaging in training or learning behavior.

j. Breaking rules (this is a reward-inhibiting trigger).

k. Any behavior nominated during market design and tracked thereafter.

Rewards

The reward 82 triggered by any process could be, e.g., of form:

1. In-house currency.

2. Legal tender.

3. Stock options in the company.

4. Other tradable assets (e.g. company shares or bonds).

5. Shares in securities offered in the in-house markets.

6. Other, non-liquid assets understood to be liquefiable, (e.g. stock options able to be exercised at a specified, future date or event.)

7. Work-related benefits such as working first shift vs. second shift, or vacation days.

8. Project assignments such as transfer to active participation on project X, and/or release from active duty on project Y.

9. Other benefits or non-tangible items provided by the company, understood to have value to a trader, e.g., professional staff member.

10. A change in rights associated with the market 12 (e.g. increased trading limits).

11. A change in rights associated with the money 14 or a security 16 (e.g., dividend rights).

Redemption

The in-house money 14 is able to be redeemed for the real rewards 82, such as items 2-7 listed in ‘Rewards’ above. The amounts and frequencies of redemption by any one trader are controlled by a formulae under executive directive, for example, to be a function of each trader's trading activity, or to be a function of the amount of the money 14 held in account, or a function of time, or the like. The formulae may also be linked to tracked behaviors.

The company preferably holds an amount of legal tender or other resources in reserve so as to allow for swift redemption when called.

Trading Rules

Trading rules help to prevent market manipulation and so ensure a fair, healthy and efficient market that generates undistorted information. An example of such a rule is “No insider trading until new insider knowledge is widely available.” Thus, in this example, project insiders must disclose information prior to trading the securities 16 based on that project. The actual rules established for a market will be strongly influenced by, e.g., company practices, organization, and informational needs, etc., in accordance with teachings of finance and governance. Another rule could be that traders must fill out any appropriate surveys, or otherwise provide information (e.g., regarding why they are trading), in order to trade.

Applications

The invention can be applied, e.g., to:

1. Forecasting.

2. Resource Allocations, e.g., funding or otherwise pursuing projects both new and existing.

3. Vendor Selection (e.g., subsequent to buy decisions).

4. Technology Acquisition.

5. Acquisitions of companies.

6. Decision making regarding asset management.

7. Delegation of business objectives to staff.

8. Cultural change strategies through motivation of targeted behaviors (e.g. team formation).

9. Asset development through motivation of targeted behaviors (e.g. knowledge sharing).

Examples

1. Use of the market 12 to forecast of an event related to technical success (as measured by some milestone). Suitably qualified professionals are certified as traders, with the rewards 82 principally associated with sound investments, and triggered by actual event outcomes.

2. Use of the market 12 to motivate knowledge sharing or documentation among the professional staff. Trading involves the citation of evidence. The rewards 82 are associated with authorship (or other relationship with evidence) and are triggered by citation.

3. Use of the market 12 to decide on a resource acquisition. The securities 16 are framed upon usage of the resource (after acquisition), with each share accompanied by rights for the holder to receive income upon usage. For example, if intellectual property (IP) or a photocopier is acquired, the holder of a security bought as an indication that the IP or copier, respectively, should be purchased would have rights to share in payments, e.g., company-controlled royalty payments if the IP is licensed or copier is used, respectively. The money 14 is associated with real budgetary allocating power and the right to spend the legal tender externally. Thus, a project leader that obtains money 14, in exchange for selling securities 16 that are ownership shares of EP proposed to be purchased, can purchase the IP if the money obtained is associated with sufficient legal tender for purchasing the IP.

4. Use of the market 12 to allocate resources to projects. The securities 16 are based on project milestones and are issued to a small group of selected traders who are the champions of the project. The securities 16 are offered for sale (a few at a time) to a second group of traders who are issued money with real budgetary allocating power.

5. Use of the market 12 to promote innovation. The securities 16 are based on people, or groups of people, taking action accepted as being part of an innovation cycle (e.g. the writing of a business plan).

6. Use of the market 12 to delegate an objective. The securities 16 are framed on achieving the objective and carry a defined reward based on successfully achieving the objective. Shares (preferably all shares) are grouped and sold at auction to a qualified group of bidders. The holding of shares is accompanied by the right to issue new securities based on a limited number of sub-divisions of the objective and its reward 82. The final securities 16, representing the smallest sub-divisions of the objective, are treated as work contracts, which are put out to tender among the professional staff. The professionals who deliver services specified by the work contracts then become holders of the securities 16, and receive its sub-divided reward when the objective is successfully achieved.

Exemplary Industry Types that may benefit from the Invention

Industries and companies can benefit from the invention where, e.g.,:

(a) the business model is significantly based on producing an on-going stream of innovative products and/or projects, i.e. a product pipeline.

(b) the time, technical difficulty or expense of the product development chain is such that the cost of failure is high.

(c) the forecasting of success and ROI assessments have significant input from professional staff with special or particular knowledge or expertise relating to the projects or products in development.

(d) The size of the company is large and/ or its operations complex.

Examples of such industries include pharmaceuticals (e.g. therapeutic drugs), aerospace, industrial instruments (e.g. measuring probes), automotive and computer hardware (e.g. mobile computing platforms).

Other embodiments are within the scope and spirit of the appended claims. For example, due to the nature of software, functions described above can be implemented using software, hardware, firmware, hardwiring, or combinations of any of these. Features implementing fimctions may also be physically located at various positions, including being distributed such that portions of functions are implemented at different physical locations.

What is claimed is:

1. A method of implementing a controlled market, the method comprising:
providing guidelines, to traders, regarding a reward associated with first entity-controlled securities that are associated with a selected project from at least one of a plurality of an entity's projects and a further associated with an event related to the selected project;
providing the first entity-controlled securities to each trader;
allowing each trader to trade the first entity-controlled securities and at least second entity-controlled securities;
acquiring, from the traders, at least some of the first entity-controlled securities; and
issuing the reward to each trader from whom the first entity-controlled security is acquired if the related event is realized;
wherein at least one of the providing the first entity-controlled securities, the allowing each trader to trade, and the issuing the reward is dependent upon a trader, to whom a first entity-controlled security is provided, from whom a first entity-controlled security is acquired, or to whom the reward is issued, taking a trader action.

2. The method of claim 1 further comprising pursuing a project based on trading of the entity-controlled securities by the traders.

3. The method of claim 2 wherein the pursuing is based on at least one of amounts of the entity-controlled securities traded by the traders for the selected project and related event, patterns of acquisition of the entity-controlled securities, and prices of the entity-controlled securities.

4. The method of claim 2 wherein the pursuing comprises at least one of funding or working on the selected project.

5. The method of claim 1 wherein the allowing the traders to trade the first entity-controlled securities includes initially allowing the traders to trade, and ongoing allowing of the traders to trade, while a project is in progress.

6. The method of claim 5 further comprising pursuing a project based at least in part on ongoing trading of the first entity-controlled securities by the traders.

7. The method of claim 5 wherein the ongoing acquiring includes trading of different entity-controlled securities.

8. The method of claim 1 wherein the trader action is at least one of responding to a survey and trading the first entity-controlled security.

9. The method of claim 1 wherein the traders have knowledge relevant to a likelihood of at least one event associated with at least one project being realized.

10. The method of claim 9 further comprising making available knowledge relevant to the projects accessible to the traders before the acquiring.

11. The method of claim 10 wherein the knowledge is made available by the traders.

12. The method of claim 1 wherein the traders acquire the entity-controlled securities by trading items of value for the entity-controlled securities.

13. The method of claim 12 further comprising distributing varying amounts of the items of value to the traders.

14. The method of claim 13 wherein the varying amounts of the items of values are dependent upon at least one of each trader's likely impact upon the realization of the event, knowledge of the likelihood of realization of the event, and taking of the trader action by the trader.

15. The method of claim 12 wherein the items of value are entity-controlled currency.

16. The method of claim 15 wherein possession of the entity-controlled currency carries at least one right associated with the entity.

17. The method of claim 16 wherein the at least one right is to obtain resource allocation for a project.

18. The method of claim 15 further comprising providing the entity-controlled currency periodically.

19. The method of claim 15 further comprising lending the entity-controlled currency to at least one of the traders.

20. The method of claim 15 further comprising exchanging the it ems of value for at least one of products, services, and work-related commodities available through an entity store.

21. The method of claim 1 wherein the related event is an end result of the selected project.

22. The method of claim 1 wherein the at least a portion of the providing, acquiring, and issuing is performed by a software program.

23. The method of claim 1 wherein at least one of the providing the first entity-controlled securities, the allowing each trader to trade, and the issuing the reward is inhibited unless the trader takes the trader action.

24. The method of claim 1 wherein possession of at least one of the first entity-controlled securities carries at least one right associated with the entity.

25. The method of claim 24 wherein the right is at least one of a right to share in profit derived from, and a right to obtain payment for use of, a resource associated with the at least one entity controlled security.

26. A method of obtaining objective feedback for projects of a company from relevant persons, the method comprising:
providing company-regulated currency to relevant persons;
providing guidelines to the relevant persons for rewards for investing in company-regulated securities associated in each of a plurality of company projects, the rewards being based on realization of a specified event associated with each project;
investing by the relevant persons in at least one of the company projects by trading the company-regulated currency for shares of project interest;
obtaining information from the relevant persons regarding trades made by the relevant persons; and
issuing the reward corresponding to each of the company-regulated securities whose associated event is realized to each trader that holds the company-regulated security upon even realization and that has provided information regarding at least one trade of the company-regulated security.

27. The method of claim 26 wherein at least one event is a milestone of a company-internal project.

28. The method of claim 26 wherein the reward is a salary bonus.

29. The method of claim 26 wherein the investing by the relevant persons is performed over a computer network regulated by the company.

30. The method of claim 29 further comprising providing computer accounts of the company-regulated currency for the relevant persons.

31. The method of claim 29 further comprising using software to log and analyze data associated with the investing, the data including information about the relevant persons that are investing and about investing activity.

32. The method of claim 26 wherein the relevant persons include employees of the company.

33. A computer program product for implementing an entity-controlled market, the computer program product residing on a computer-readable medium and comprising computer-executable instructions for causing a computer to:
provide guidelines, to traders, regarding a reward associated with first entity-controlled securities that are associated with a selected project from at least one of a plurality of an entity's projects and a further associated with an event related to the selected project;
provide the first entity-controlled securities to each trader;
allow each trader to trade the first entity-controlled securities and at least second entity-controlled securities;
acquire, from the traders, at least some of the first entity-controlled securities; and
issue the reward to each trader from whom the first entity-controlled security is acquired if the related event is realized;
wherein the instructions are configured to at least one of provide the first entity-controlled securities, allow each trader to trade, and issue the reward depending upon a trader, to whom a first entity-controlled security is provided, from whom a first entity-controlled security is acquired, or to whom the reward is issued, taking a trader action.

34. The computer program product of claim 33 wherein the trader action is at least one of responding to a survey and trading the first entity-controlled security.

35. The computer program product of claim 33 further comprising instructions for causing the computer to make knowledge relevant to all the projects accessible to all the traders before the computer acquires the first entity-controlled securities.

36. The computer program product of claim 33 further comprising instructions for causing the computer to distribute varying amounts of the items of value to the traders for obtaining the first entity-controlled securities.

37. The computer program product of claim 36 wherein the varying amounts of the items of values are dependent upon at least one of each trader's likely impact upon the realization of the event, knowledge of the likelihood of realization of the event, and taking of the trader action by the trader.

38. The computer program product of claim 33 wherein the related event is an end result of the selected project.
